(19) United States
(12) Patent Application Publication
(10) Pub. No.: US 2024/0323107 A1
(43) Pub. Date: Sep. 26, 2024

(54) IDENTIFYING NETWORK CONDITIONS ASSOCIATED WITH APPLICATION STATES

(71) Applicant: Cisco Technology, Inc., San Jose, CA (US)

(72) Inventors: Eduard Schornig, Haarlem (NL); Jean-Philippe VASSEUR, Combloux (FR); Grégory MERMOUD, Venthône (CH); Romain KAKKO-CHILOFF, Paris (FR)

(21) Appl. No.: 18/125,396

(22) Filed: Mar. 23, 2023

(51) Int. Cl. H04L 41/5067; H04L 41/0631; H04L 43/08

(52) U.S. Cl. CPC H04L 41/5067; H04L 41/0631; H04L 43/08

(57) ABSTRACT

In one embodiment, a device receives application performance metrics generated by an online application accessible via a network and indicative of a particular state of the online application. The device performs testing of the online application by replicating a plurality of network impairments. The device associates, based on results of the testing, a particular network impairment from plurality of network impairments with the particular state of the online application. The device provides an indication of the particular network impairment as a cause of the particular state of the online application.

### TECHNICAL FIELD

The present disclosure relates generally to computer networks, and, more particularly, to identifying network conditions associated with application states.

### BACKGROUND

In recent years, Enterprise Networks have undergone a fundamental transformation, as users and applications have become increasingly distributed and the network perimeter has expanded to include diverse connectivity technologies such as Software Defined Wide Area Networks (SD-WANs, remote work, Secure Access Service Edge (SASE), and Zero Trust Network Access (ZTNA), as well as new application and content delivery models such as Infrastructure as a Service (IaaS), Software as a Service (SaaS), and Hybrid Cloud.

In this new and dynamic environment, network administrators are still held accountable for ensuring that the network delivers online applications with a high quality of experience (QoE), irrespective of how user connect to the network, where the users are located, or where the application is hosted. For instance, network conditions could cause an audio, video, and collaboration (AVC) application to freeze or provide poor audio to its users.

Application delivery now relies on the successful interworking of multiple distinct network domains: last mile provider, corporate network, transit service providers, cloud security provider, and application vendors. However, network administrators have limited or no visibility and control on the end-to-end traffic path, as monitoring the connectivity between diverse end user locations (remote workers, home offices, small branches) and dynamic applications distributed to multiple cloud regions or even cloud providers becomes unfeasible. Moreover, monitoring the application infrastructure is now the responsibility of the SaaS vendor, removing yet another layer of visibility.

As a result, network administrators face an increasingly difficult task when trying to understand whether poor application QoE is a result of a degraded network path (e.g., packet loss, increased latency, etc.) or instead the result of application-level issues (e.g., an overloaded server in the SaaS provider infrastructure) or even endpoint-level issues (e.g., high CPU utilization by the client device).

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for identifying network conditions associated with application states;

FIG. 6 illustrates an example display of network impairments associated with an application state; and

FIG. 7 illustrates an example simplified procedure for identifying network conditions associated with application states.

### DESCRIPTION OF EXAMPLE EMBODIMENTS

### Overview

According to one or more embodiments of the disclosure, a device receives application performance metrics generated by an online application accessible via a network and indicative of a particular state of the online application. The device performs testing of the online application by replicating a plurality of network impairments. The device associates, based on results of the testing, a particular network impairment from plurality of network impairments with the particular state of the online application. The device provides an indication of the particular network impairment as a cause of the particular state of the online application.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

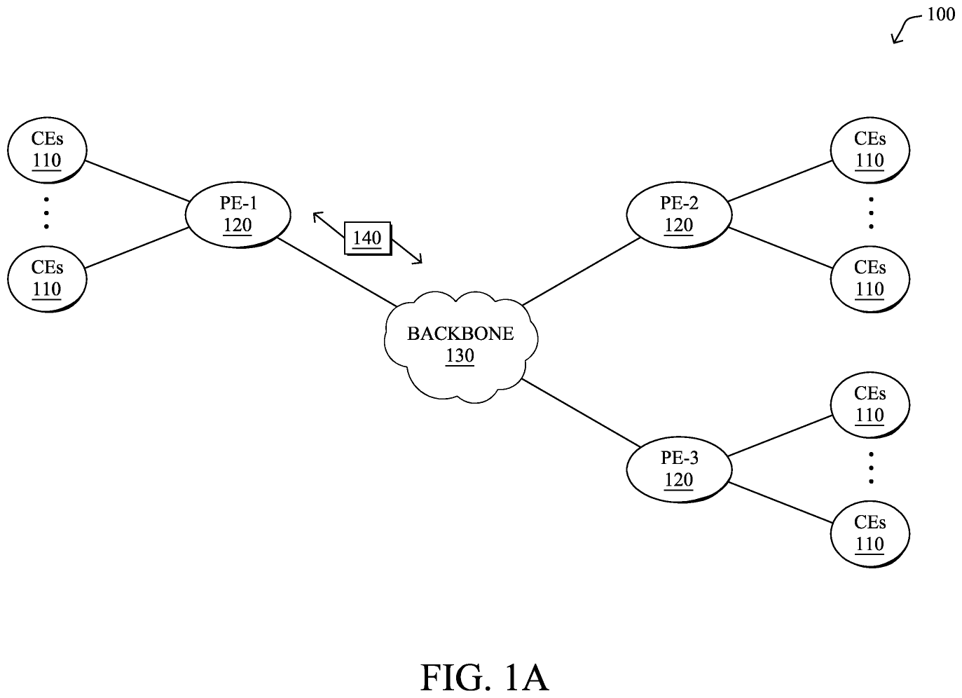

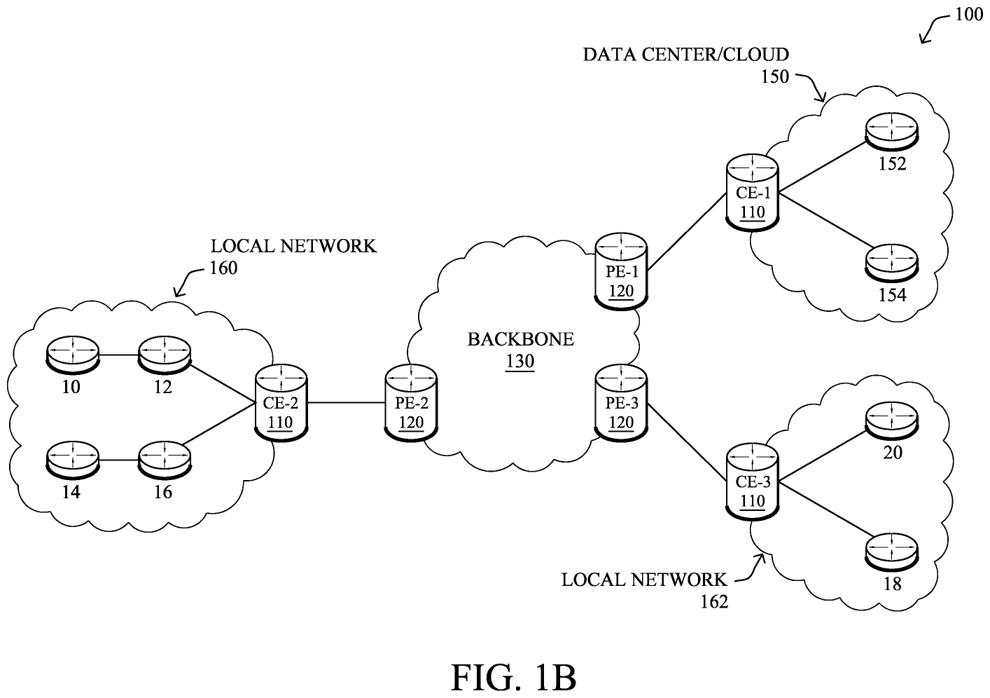

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

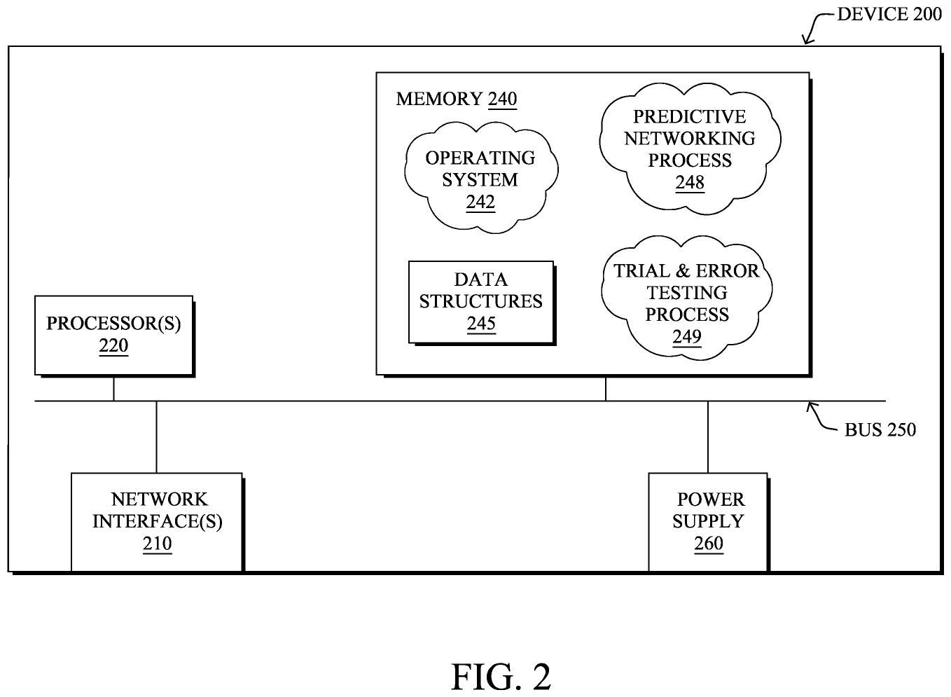

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a predictive networking process 248 and/or trial and error testing process 249, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, predictive networking process 248 and/or trial and error testing process 249 may include computer executable instructions that, when executed by processor(s) 220, cause device 200 to perform the techniques described herein. To do so, in some embodiments, predictive networking process 248 and/or trial and error testing process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, predictive networking process 248 and/or trial and error testing process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that predictive networking process 248 and/or a recommendation policy manager process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software as a service (SaaS) is having a dramatic impact of the overall Internet due to the extreme virtualization of services and shift of traffic load in many large enterprises. Consequently, a branch office or a campus can trigger massive loads on the network.

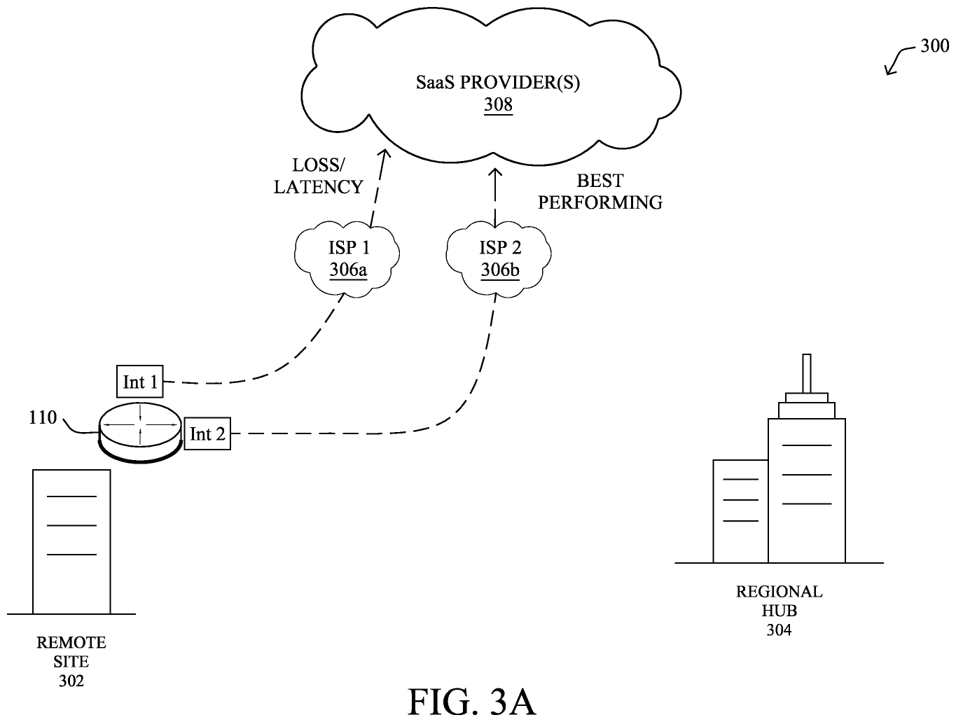

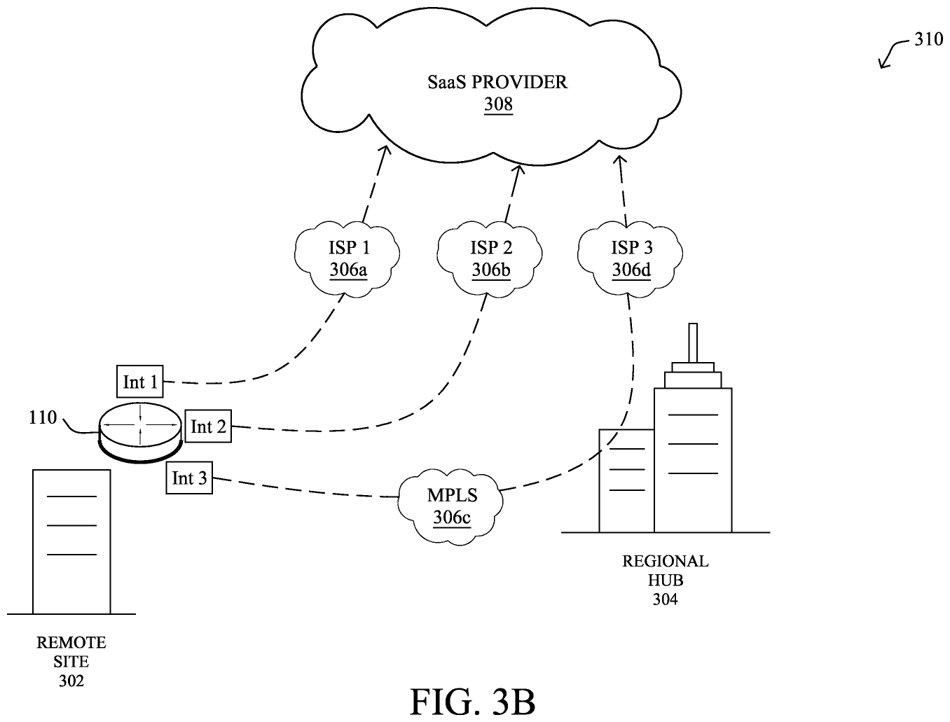

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G. 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

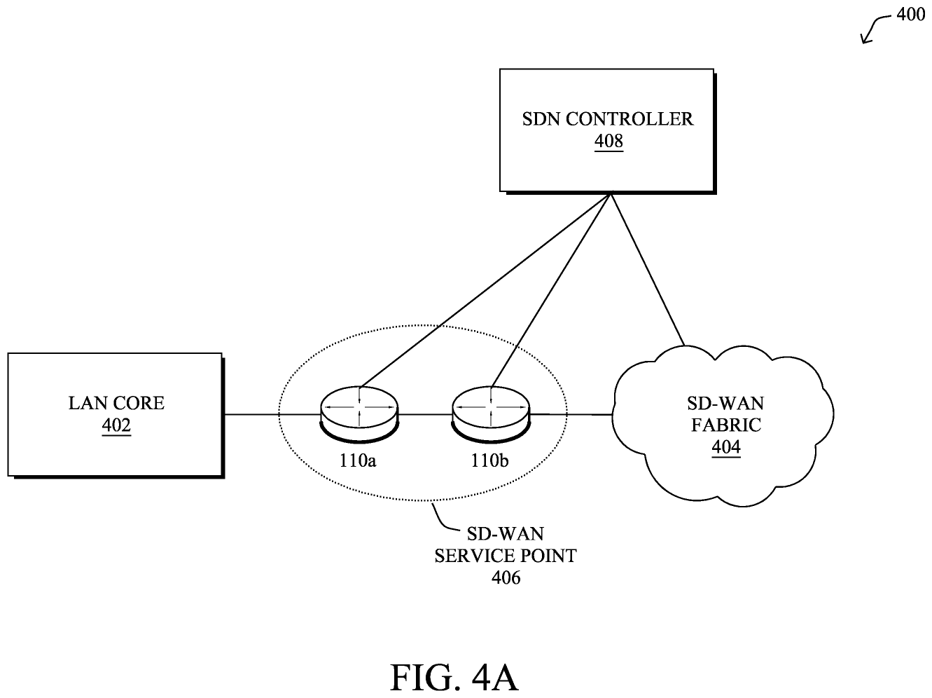

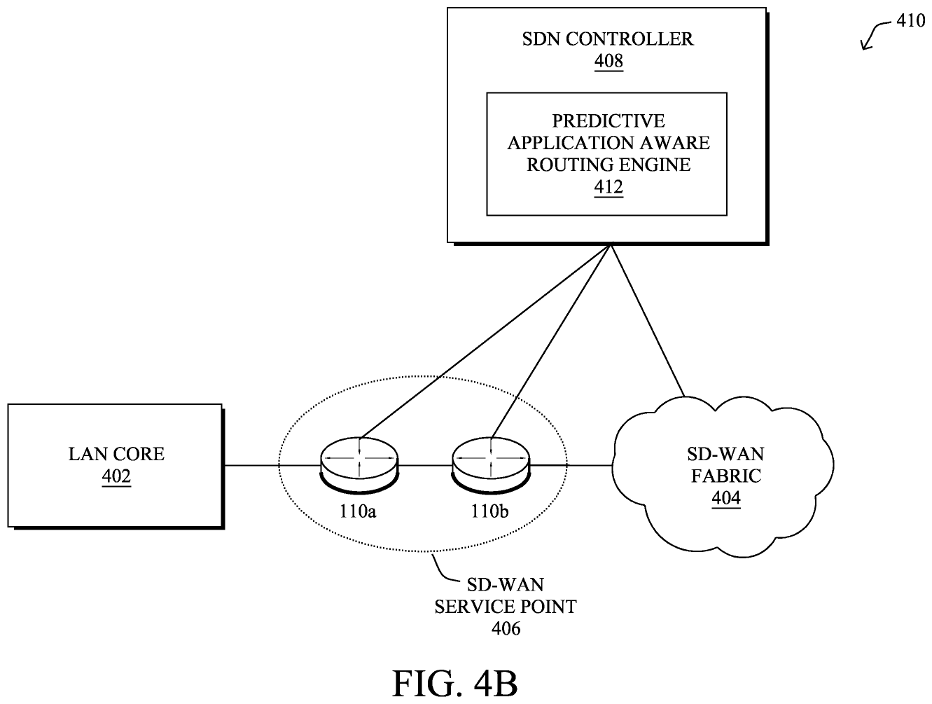

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side. SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g . . . a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela. CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of predictive networking process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches.” which are typically temporary in nature (e.g., active for a specified period of time) and may also be application-specific (e.g., for traffic of one or more specified applications).

In more advanced embodiments, predictive application aware routing engine 412 may predict the QoE of a given application through any or all of the following:
Obtaining user feedback directly from the application. For instance, users of the application may provide ratings, satisfaction surveys, or the like, which predictive application aware routing engine 412 could access via an application programming interface (API) of the application
Applying traffic analytics, such as by analyzing Netflow records that include extra metrics like Application Response Time (ART).
Sending synthetic path probes to measure networking metrics to each SaaS application from each location. These probes are ‘synthetic’ in that they seek to mimic the actual characteristics of the traffic of the application under scrutiny.

As noted above, in recent years, Enterprise Networks have undergone a fundamental transformation, as users and applications have become increasingly distributed and the network perimeter has expanded to include diverse connectivity technologies such as Software Defined Wide Area Networks (SD-WANs, remote work, Secure Access Service Edge (SASE), and Zero Trust Network Access (ZTNA), as well as new application and content delivery models such as Infrastructure as a Service (IaaS), Software as a Service (SaaS), and Hybrid Cloud.

In this new and dynamic environment, network administrators are still held accountable for ensuring that the network delivers online applications with a high quality of experience (QoE), irrespective of how user connect to the network, where the users are located, or where the application is hosted. For instance, network conditions could cause an audio, video, and collaboration (AVC) application to freeze or provide poor audio to its users.

Application delivery now relies on the successful interworking of multiple distinct network domains: last mile provider, corporate network, transit service providers, cloud security provider, and application vendors. However, network administrators have limited or no visibility and control on the end-to-end traffic path, as monitoring the connectivity between diverse end user locations (remote workers, home offices, small branches) and dynamic applications distributed to multiple cloud regions or even cloud providers becomes unfeasible. Moreover, monitoring the application infrastructure is now the responsibility of the SaaS vendor, removing yet another layer of visibility.

As a result, network administrators face an increasingly difficult task when trying to understand whether poor application QoE is a result of a degraded network path (e.g., packet loss, increased latency, etc.) or instead the result of application-level issues (e.g., an overloaded server in the SaaS provider infrastructure) or even endpoint-level issues (e.g., high CPU utilization by the client device).

Unfortunately, modeling the relationship between Layer 3 (i.e., network-level) metrics and Layer 7 (i.e., application-level) metrics is often difficult and challenging to capture all such relationships.

### Identifying Network Conditions Associated with Application States

The techniques herein take as input a set of Layer 7 (i.e. application-level) metrics known as being disruptive to the QoE and then utilizes a trial and error approach to reproduce networking phenomena that are the most likely to be responsible for specific degradations, particularly in situations where a QoE prediction model cannot easily be built to consider both Layer 3 and Layer 7 metrics. In some aspects, the techniques rely on a top-down approach, from the perspective of the OSI Layer model, where application related metrics can be gathered for which the network cannot map networking phenomenon. In turn, application states of interest can be selected either by an operator based on prior knowledge (e.g., users from a particular site complaining of poor QoE) or by clustering the application telemetry, to identify groups of reports with similar application metrics and poor QoE scores. For example, at this stage, the system may identify a group of performance reports with high values for Layer 7 application performance metrics, such as audio and video concealment times that result in a poor QoE score.

Further aspects of the techniques herein take a trial and error approach to replicate network phenomena in a controlled environment and discover which types of network phenomenon (conditions) are most likely to reproduce the initial set of application performance metrics. In one example, the system may replicate multiple network phenomenon and determine that the specific combination of audio and video concealment time is likely to be the outcome of a congested last mile connection or some specific amount packet loss between the media server and end user. In another example, the system may not find a matching network phenomenon, indicating that the poor QoE may be caused by issues pertaining to the user endpoint or the application itself.

Illustratively, the techniques described herein may be performed by hardware, software, and/or firmware, such as in accordance with trial and error testing process 249, which may include computer executable instructions executed by the processor 220 (or independent processor of interfaces 210) to perform functions relating to the techniques described herein, in conjunction with predictive networking process 248.

Specifically, according to various embodiments, a device receives application performance metrics generated by an online application accessible via a network and indicative of a particular state of the online application. The device performs testing of the online application by replicating a plurality of network impairments. The device associates, based on results of the testing, a particular network impairment from plurality of network impairments with the particular state of the online application. The device provides an indication of the particular network impairment as a cause of the particular state of the online application.

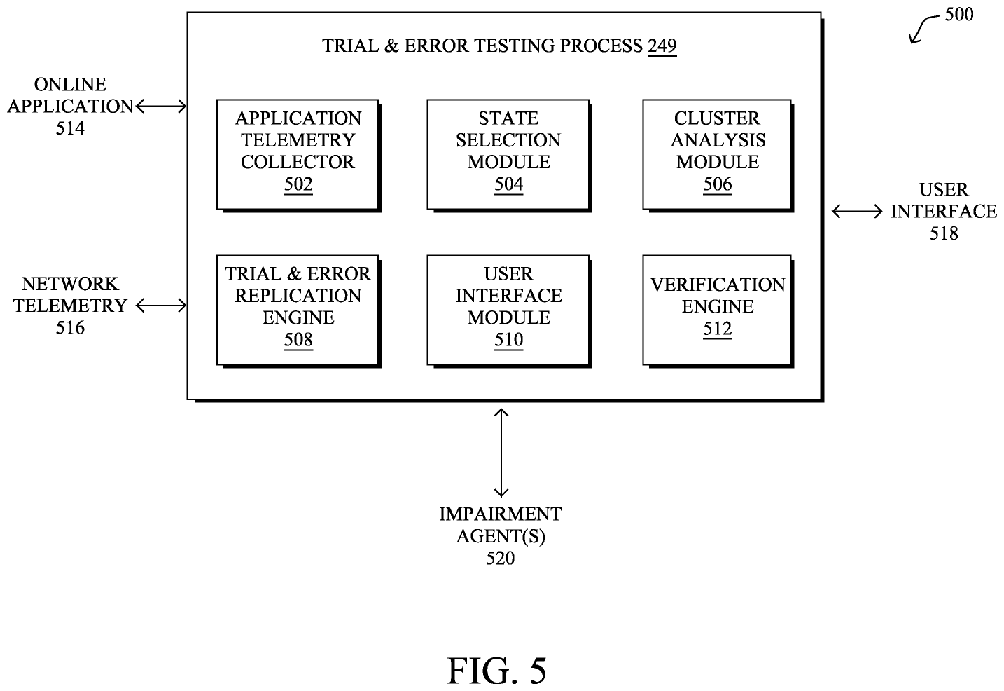

Operationally, FIG. 5 illustrates an example architecture for identifying network conditions associated with application states, according to various embodiments. At the core of architecture 500 is trial and error testing process 249, which may be executed by a controller for a network or another device in communication therewith. For instance, trial and error testing process 249 may be executed by a controller for a network (e.g., SDN controller 408 in FIGS. 4A-4B), a particular networking device in the network (e.g., a router, etc.), another device or service in communication therewith, or the like, to provide a supervisory service to the network. More specifically, trial and error testing process 249 may operate in conjunction with a predictive application aware routing engine (e.g., that through execution of predictive networking process 248), such as predictive application aware routing engine 412, or directly implemented as a component thereof, in some embodiments.

As shown, trial and error testing process 249 may include any or all of the following components: application telemetry collector 502, state selection module 504, cluster analysis module 506, trial and error replication engine 508, user interface module 510, and/or verification engine 512. As would be appreciated, the functionalities of these components may be combined or omitted, as desired. In addition, these components may be implemented on a singular device or in a distributed manner, in which case the combination of executing devices can be viewed as their own singular device for purposes of executing trial and error testing process 249.

During execution, application telemetry collector 502 may leverage one or more APIs to query an online application 514 for application performance telemetry and/or user metadata. Doing so allows trial and error testing process 249 to collect telemetry from the SaaS vendor that include Layer 7 performance metrics that ultimately characterize the behavior of online application 514 and could not be retrieved or inferred via other monitoring approaches. In various embodiments, application telemetry collector 502 may obtain any or all of the following application performance metrics, among others:
Audio/Video Concealment Time (Mean, Max)
Audio/Video Available Bit Rate and Utilized Bit Rate
Video Resolution
Video RX/TX Frame Rate
Audio/Video Buffer Delay
Any other performance metric that online application 514 may generate

Application vendors may also provide visibility to application telemetry collector 502 into Layer 3 network metrics such as loss, latency, and/or jitter, contextualized per traffic direction (i.e., transmit or receive) or by scope (e.g., end-to-end accounting for traffic between end users involved in the same meeting or hop-by-hop accounting for traffic between each user and the application or media server endpoints). While Layer 3 network telemetry can otherwise be collected via other means (e.g., active probes, BFD etc.) it rarely provides full coverage of the path between the user and the application. In another embodiment, online application 514 may also provide a user experience score (UES) to application telemetry collector 502 that represents an estimated measure of user satisfaction with online application 514.

Application telemetry collector 502 may also enrich the above information with additional information from the Enterprise Network domain, such as network telemetry 516, which it may obtain from online application 514 and/or sources within the enterprise network (e.g., a network controller, a telemetry exporter, etc.). In various embodiments, this additional information may indicate any or all of the following:
Location type: e.g., remote worker, branch, campus, etc.
WAN Access technology: LTE, ADSL, satellite, fiber, etc.
Internet access strategy: e.g., whether the application traffic was offloaded to a cloud security provider or a data center firewall, or even directly through the Internet.
Information related to important enterprise events, as well. For instance, application telemetry collector 502 may also receive an indication that users have participated in a companywide virtual event or summit.

In various embodiments, state selection module 504 may be responsible for determining which application states are of interest and should be selected for replication, according to various embodiments. In one embodiment state selection module 504 may simply rely on user input to select the application states of interest via a user interface 518. In this case, the user could simply indicate which application states are to be reproduced by selecting one or several reports of interest. For example, an operator could get support tickets from users in a given site and ask state selection module 504, via user interface 518, to determine the kind(s) of network impairments that led to the reports representative of this particular site.

In a second embodiment, state selection module 504 may leverage clustering to denoise the input Layer 3 (network) and Layer 7 (application) metrics and group them together those application states with “similar” network and application conditions. The objective here is to compute a set of finite application and (potentially) network states. It is worth pointing out that state selection module 504 may also restrict such states to application (Layer 7) states, even when no information is provided about Layer 3.

In other words, state selection module 504 may seek to identify the network states corresponding to those application states of interest, where a state of interest is either selected by an operator via user interface 518 or represented by a cluster computed by some machine learning algorithm. In the clustering case, state selection module 504 may use an unsupervised approach that directly inputs the telemetry and other metrics obtained by application telemetry collector 502 and creates groups of reports sharing similar patterns of network and/or application conditions. In this context, the clustering algorithm acts as a tool that assigns each report to a group and enables further analysis of the various and repeating patterns of Layer 3 or Layer 7 conditions.

When QoE metrics are also available, clusters computed by state selection module 504 may also have a distribution of QoE scores. In turn, state selection module 504 may select clusters with a lower distribution of QoE scores for further analysis as they can point to recurring network patterns that have a negative impact on user experience. Discovering such network phenomenon leading to poor QoE can be quite important. The threshold for this selection can be defined by the network administrator via user interface 518. For instance, the administrator may specify that only clusters with overall UES scores lower than 3.5 are of interest and would warrant further analysis.

When state selection module 504 makes use of a clustering approach, it may also do so in conjunction with cluster analysis module 506 which is responsible for understanding the composition of poor QoE clusters produced by state selection module 504 and estimating the lower and upper bounds for each set of Layer 3 and/or Layer 7 KPIs by leveraged the clustering model to decode the centroid of a specific cluster into expected lower and upper bounds.

In various embodiments, trial and error replication engine 508 may take as input the list of Layer 7 application metrics and attempts to reproduce these in a controlled simulation environment where various types of network disruptions are introduced, thus helping the discovery of the network conditions that led to those applications states. To do so, trial and error replication engine 508 may define an initial set of impairment scenarios that can be tried in the simulation environment, and which are expected to produce application performance reports with application performance metrics that fall within the received input bounds, specific to each cluster or user selected set of reports.

Each impairment scenario may be defined by a set of parameters such as loss, latency, jitter, available circuit bandwidth, background load, combinations thereof, or the like, and may also apply to one or more users for various spans of types or times. For instance, one such impairment scenario may be as follows:

TABLE 1

| | Receive | Transmit |
|---|---|---|
| Baseline Delay (ms) | 85 | 85 |
| Delay (ms) | 135 | 85 |
| Jitter | 0 | 0 |
| Loss (%) | 0 | 0 |
| Bandwidth Shaping | 0 | 0 |
| Link Load (%) | 0 | 0 |
| Burst Duration (ms) | 30000 | 300000 |
| Break Duration (ms) | 30000 | 10 |

Yet another impairment scenario may be as follows:

TABLE 2

| | Receive | Transmit |
|---|---|---|
| Baseline Delay (ms) | 100 | 100 |
| Delay (ms) | 0 | 0 |
| Jitter | 0 | 0 |
| Loss (%) | 25% | 0 |
| Bandwidth Shaping | 0 | 0 |
| Link Load (%) | 0 | 0 |
| Burst Duration (ms) | 1000 | 300000 |
| Break Duration (ms) | 2000 | 10 |

As a further example, another impairment scenario may be as follows:

TABLE 3

| | Receive | Transmit |
|---|---|---|
| Baseline Delay (ms) | 85 | 85 |
| Delay (ms) | 0 | 0 |
| Jitter | 500 | 500 |
| Loss (%) | 0 | 0 |
| Bandwidth Shaping | 0 | 0 |
| Link Load (%) | 0 | 0 |
| Burst Duration (ms) | 30000 | 300000 |
| Break Duration (ms) | 10 | 10 |

Initially, cluster analysis module 506 may craft impairment scenarios using a set of rules defined by domain experts (e.g., via user interface 518) based on prior knowledge of the interaction between application metrics and network conditions. Indeed, it may be known that application metrics such as audio buffer delay are easily influenced by increased latency. Accordingly, trial and error replication engine 508 may start its search by simulating impairments based on latency variations. In another example, trial and error replication engine 508 may look to simulate audio and video concealment times which are known to be caused mainly by packet loss.

In various embodiments, trial and error replication engine 508 may also function as an impairment controller, or communicate with such a controller, to orchestrate an end-to-end test for a given impairment scenario using any number of impairment agent(s) 520 assigned to each user. The purpose of impairment agent(s) 520 is to automate the participant actions (e.g., join, leave, send voice/video) using such an impairment scenario and record the test results.

Once a test is completed, trial and error replication engine 508 may operate in conjunction with application telemetry collector 502 to obtain the corresponding application telemetry for the test and check whether the values for the target application metrics are similar to those of the input reports (e.g., support tickets). If the results are positive, trial and error replication engine 508 may stop the replication process and associate the application state, input reports, and matched impairment scenario with one another.

Of course, in the case that none of the tested impairment scenarios managed to replicate the initial application state/set of application performance metrics, trial and error replication engine 508 may repeat the testing using different impairment scenarios until a match is found.

In some cases, trial and error replication engine 508 may determine that a particular set of Layer 7/application performance metrics cannot be replicated by manipulating network conditions, which can also be a valuable insight as it may point to issues at the application layer or with the end user endpoint.

In the beginning, trial and error replication engine 508 may require many trials to find suitable matches. However, over time, an increasingly comprehensive library of network phenomenon and their corresponding impact on the Layer 7/application metrics is built which can greatly optimize future searches.

The task accomplished by trial and error replication engine 508 may be achieved using an optimization approach such as Genetic Algorithms, Particle Swarm Optimization, or Bayesian optimization. Indeed, one might cast the entire problem as an error minimization in high-dimensional space, whereby the objective is to replicate as closely as possible a given set of Layer 7/application performance metrics (or interval thereof) by searching a large space of possible impairment scenarios. In this context, trial and error replication engine 508 could encode the scenarios as a vector of continuous and/or discrete values, which may represent the genotype of an individual (in the context of Genetic Algorithms) or the position of a particle (in the context of Particle Swarm Optimization). Then, the optimization algorithm of trial and error replication engine 508 may suggest new experiments to be performed, thus probing different regions of the space and “direct” the search towards regions that are more likely to replicate the scenario of interest. It should also be noted that such approaches are also amenable to multi-objective searches (which is of interest in the context of trial and error replication engine 508) and constrained optimization (i.e., disallowing the search in unfeasible regions of the space), either or both of which could also be used.

In various embodiments, user interface module 510 may be responsible for providing data for display to user interface 518 and receiving data therefrom. In one embodiment, user interface module 510 may provide display data to user interface 518, to allow the user to inspect the outputs of each component of the system. For instance, when QoE metrics (distribution) are available and assigned to a cluster, the user may use the QoE to filter out the set of clusters of prime interest. Valuable insights may also be gained by reviewing the composition the poor QoE clusters found as it pertains to types of devices used, geographic distribution, connectivity type, time of day and more.

In another view, user interface module 510 may display the information related to which application performance metrics are most important for each cluster. A further view could also present the network phenomenon found for each cluster by trial and error replication engine 508.

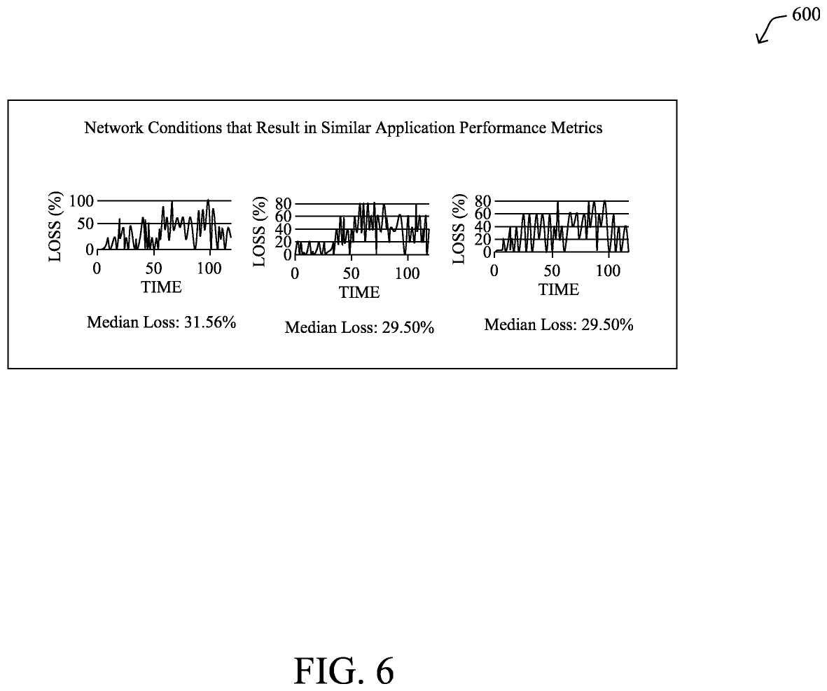

For example, using one view, a network administrator can identify a poor QoE cluster with reports predominantly from users connected over satellite connectivity, use the next UI view to understand the nature of the degradation (for example: low video resolution), before finally moving to the third view to review a list of network phenomenon that are likely to be the cause of the issue. By way of example, FIG. 6 illustrates an example display 600 of the potential network conditions from the trial and error testing that resulted in similar application performance metric, which may be associated with a set of support tickets of interest. These valuable insights can then be used to as a starting point for more traditional troubleshooting approaches such as deploying dedicated debugging and monitoring or to directly devise mitigation strategies.

As shown in FIG. 5, verification engine 512 may be configured to verify the outputs of trial and error replication engine 508 in the network. More specifically, once trial and error replication engine 508 has successfully replicated a scenario, verification engine 512 may identify a set of nodes in the network that experiences similar network conditions and retrieves the QoE for the respective users, in order to validate the outputs of trial and error replication engine 508. This validation can then be shown to a user (e.g., by user interface module 510 via user interface 518) or even used to refine the testing done by trial and error replication engine 508

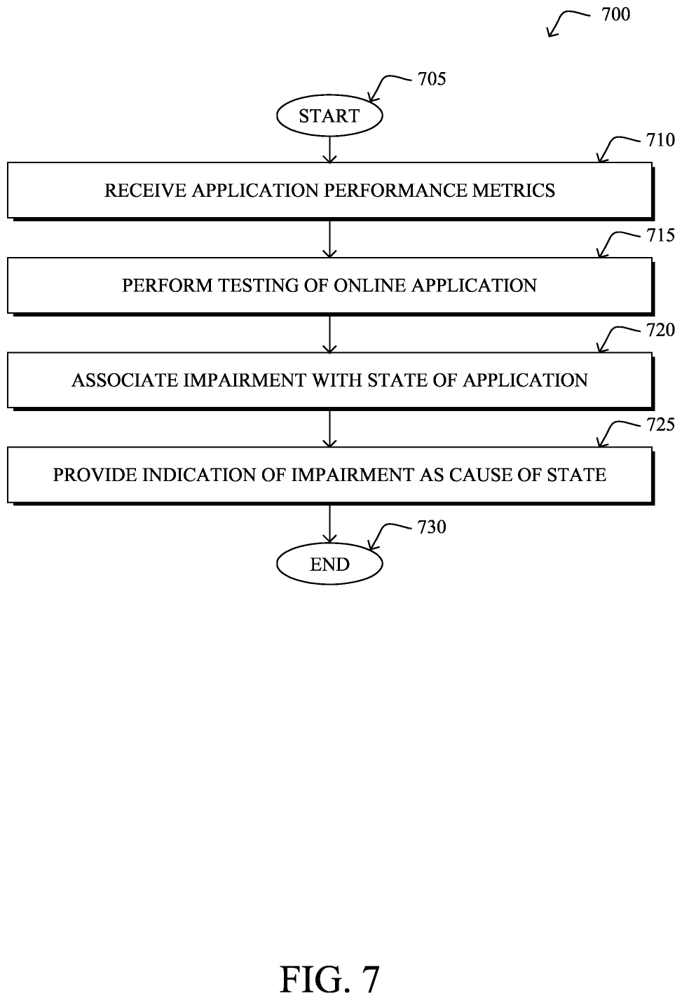

FIG. 7 illustrates an example simplified procedure 700 (e.g., a method) procedure for identifying network conditions associated with application states, in accordance with one or more embodiments described herein. For example, a non-generic, specifically configured device (e.g., device 200) may perform procedure 700 by executing stored instructions (e.g., recommendation policy manager process 249, potentially in conjunction with predictive networking process 248). The procedure 700 may start at step 705, and continues to step 710, where, as described in greater detail above, the device may receive application performance metrics generated by an online application accessible via a network and indicative of a particular state of the online application. In various embodiments, the application performance metrics comprise one or more of: an audio or video concealment time, a bit rate, a video resolution, a frame rate, or a buffer delay. In some embodiments, the application performance metrics are associated with poor quality of experience of users of the online application. In yet another embodiment, the device may also use clustering on the application performance metrics to identify the particular state of the online application.

At step 715, as detailed above, the device may perform testing of the online application by replicating a plurality of network impairments. In various embodiments, the plurality of network impairments comprises one or more of: increased loss, increased latency, increased jitter, decreased bandwidth, or background load, imposed on traffic associated with the online application. In various embodiments, the device may do so by instructing one or more agents in the network to impose the plurality of network impairments on traffic associated with the online application. In some embodiments, the one or more agents automate user actions within the online application. In one embodiment, the application performance metrics are associated with a location type and the testing of the online application replicates traffic for the online application from that location type. In another embodiment, the application performance metrics are associated with a wide area network access technology and the testing of the online application replicates traffic for the online application sent via that wide area network access technology. In yet another embodiment, the application performance metrics are associated with an Internet access strategy and the testing of the online application replicates traffic for the online application sent via using that Internet access strategy.

At step 720, the device may associate, based on results of the testing, a particular network impairment from plurality of network impairments with the particular state of the online application, as described in greater detail above. More specifically, the device may assess the application performance metrics that resulted from a given test with a certain network impairment, to see whether that impairment resulted in similar application performance metrics associated with the particular state of the online application.

At step 725, as detailed above, the device may provide an indication of the particular network impairment as a cause of the particular state of the online application. For instance, the device may provide the indication to a user interface for display, to a predictive networking engine, or the like.

Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for identifying network conditions associated with application states, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
receiving, at a device, application performance metrics generated by an online application accessible via a network and indicative of a particular state of the online application;
performing, by the device, testing of the online application by replicating a plurality of network impairments to result in test results that could substantially match the application performance metrics;
associating, by the device and based on a set of test results substantially matching the application performance metrics, a particular network impairment from the plurality of network impairments that corresponds to the set of test results with the particular state of the online application; and
providing, by the device, an indication of the particular network impairment as a cause of the particular state of the online application.

2. The method as in claim 1, wherein the plurality of network impairments comprises one or more of: increased loss, increased latency, increased jitter, decreased bandwidth, or background load, imposed on traffic associated with the online application.

3. The method as in claim 1, wherein the application performance metrics comprise one or more of: an audio or video concealment time, a bit rate, a video resolution, a frame rate, or a buffer delay.

4. The method as in claim 1, wherein performing the testing of the online application by replicating a plurality of network impairments comprises:
instructing one or more agents in the network to impose the plurality of network impairments on traffic associated with the online application.

5. The method as in claim 4, wherein the one or more agents automate user actions within the online application.

6. The method as in claim 1, wherein the application performance metrics are associated with a location type, and wherein the testing of the online application replicates traffic for the online application from that location type.

7. The method as in claim 1, wherein the application performance metrics are associated with a wide area network access technology, and wherein the testing of the online application replicates traffic for the online application sent via that wide area network access technology.

8. The method as in claim 1, wherein the application performance metrics are associated with an Internet access strategy, and wherein the testing of the online application replicates traffic for the online application sent via using that Internet access strategy.

9. The method as in claim 1, wherein the application performance metrics are associated with poor quality of experience of users of the online application.

10. The method as in claim 1, further comprising:
using clustering on the application performance metrics to identify the particular state of the online application.

11. An apparatus, comprising:
one or more network interfaces;
a processor coupled to the one or more network interfaces and configured to execute one or more processes; and
a memory configured to store a process that is executable by the processor, the process when executed configured to:
receive application performance metrics generated by an online application accessible via a network and indicative of a particular state of the online application;
perform testing of the online application by replicating a plurality of network impairments to result in test results that could substantially match the application performance metrics;
associate, based on a set of test results substantially matching the application performance metrics, a particular network impairment from the plurality of network impairments that corresponds to the set of test results with the particular state of the online application; and
provide an indication of the particular network impairment as a cause of the particular state of the online application.

12. The apparatus as in claim 11, wherein the plurality of network impairments comprises one or more of: increased loss, increased latency, increased jitter, decreased bandwidth, or background load, imposed on traffic associated with the online application.

13. The apparatus as in claim 11, wherein the application performance metrics comprise one or more of: an audio or video concealment time, a bit rate, a video resolution, a frame rate, or a buffer delay.

14. The apparatus as in claim 11, wherein the apparatus performs the testing of the online application by replicating a plurality of network impairments by:
instructing one or more agents in the network to impose the plurality of network impairments on traffic associated with the online application.

15. The apparatus as in claim 14, wherein the one or more agents automate user actions within the online application.

16. The apparatus as in claim 11, wherein the application performance metrics are associated with a location type, and wherein the testing of the online application replicates traffic for the online application from that location type.

17. The apparatus as in claim 11, wherein the application performance metrics are associated with a wide area network access technology, and wherein the testing of the online application replicates traffic for the online application sent via that wide area network access technology.

18. The apparatus as in claim 11, wherein the application performance metrics are associated with an Internet access strategy, and wherein the testing of the online application replicates traffic for the online application sent via using that Internet access strategy.

19. The apparatus as in claim 11, wherein the application performance metrics are associated with poor quality of experience of users of the online application.

20. A tangible, non-transitory, computer-readable medium storing program instructions that cause a device to execute a process comprising:
receiving, at the device, application performance metrics generated by an online application accessible via a network and indicative of a particular state of the online application;
performing, by the device, testing of the online application by replicating a plurality of network impairments to result in test results that could substantially match the application performance metrics;
associating, by the device and based on a set of test results substantially matching the application performance metrics, a particular network impairment from the plurality of network impairments that corresponds to the set of test results with the particular state of the online application; and
providing, by the device, an indication of the particular network impairment as a cause of the particular state of the online application.
